(19) United States
(12) Patent Application Publication
(10) Pub. No.: US 2024/0227449 A1
(43) Pub. Date: Jul. 11, 2024

(54) PNEUMATIC VEHICLE TYRES COMPRISING A CARCASS PLY

(71) Applicant: Continental Reifen Deutschland GmbH, Hannover (DE)

(72) Inventors: Seyedomidreza Biabanaki, Hannover (DE); Volkmar Fries, Wedemark (DE); Michael Lehn, Celle (DE); Carsten von Zobeltitz, Seelze (DE); Dong Zheng, Hannover (DE)

(73) Assignee: Continental Reifen Deutschland GmbH, Hannover (DE)

(21) Appl. No.: 18/570,613

(22) PCT Filed: Dec. 7, 2021
(86) PCT No.: PCT/DE2021/200245

§ 371 Date: Dec. 14, 2023

(30) Foreign Application Priority Data
Jun. 25, 2021 (DE) 10 2021 206 626.7

(51) Int. Cl. B60C 9/02; B60C 11/03

(52) U.S. Cl. CPC B60C 9/0292; B60C 2011/0341; B60C 2200/06

(57) ABSTRACT

The invention relates to a pneumatic vehicle tire, in particular a utility vehicle tire, having a tread with a circumferential groove, and having a carcass with a carcass ply which has, in a cross section of the tire, a carcass ply line running through the central points of the strength members of the carcass ply, wherein said cross section is the cross section in the circumferential direction U that the tire would have in the new state if it were mounted on a standard wheel rim conforming to E.T.R.T.O. without filling pressure.

### CROSS-REFERENCE TO RELATED APPLICATIONS

The present application is a National Stage Application under 35 U.S.C. § 371 of International Patent Application No. PCT/DE2021/200245 filed on Dec. 7, 2021, which claims priority from German Patent Application No. 10 2021 206 626.7 filed on Jun. 25, 2021, the disclosures of which are herein incorporated by reference in their entireties.

### BRIEF SUMMARY

The invention relates to a pneumatic vehicle tire, in particular a utility vehicle tire, having a tread with a tread surface and a shoulder-side circumferential groove running in encircling fashion around the circumference of the tire, and having a carcass with a carcass ply having strength members, wherein the carcass ply has, in a cross section of the tire, a carcass ply line running through the central points of the strength members of the carcass ply, wherein said cross section is the cross section in the circumferential direction U that the tire would have in the new state if it were mounted on a standard wheel rim conforming to E.T.R.T.O. without filling pressure.

A pneumatic vehicle tire generally has an air-impermeable inner layer, an in particular radial carcass which extends from the zenith region of the tire via the sidewalls into the bead region and is normally anchored there by being looped around tension-resistant bead cores, a radially externally located profiled tread, and a belt arranged between the tread and the carcass.

A pneumatic vehicle tire mounted on a wheel rim undergoes a change in its outer contour when, proceeding from a state without filling pressure (i.e. at atmospheric pressure), the filling pressure of the tire is increased to the filling pressure intended for operation of the tire. Pneumatic vehicle tires, the carcass ply of which is guided on the tire mounted without filling pressure as customary largely rectilinearly from an axial center of the tire into the shoulder regions, undergo, specifically in the shoulder region, more significant growth radially toward the outside than in the axial center of the tire. This can lead to an opening of the circumferential groove and to tangential stress in the groove base, which can result in fatigue cracks in the circumferential groove during operation of the tire.

In order to enable more uniform growth when filling the pneumatic vehicle tire, EP 3212441 A1 discloses optimizing the arrangement of the carcass ply.

During operation, in particular during the first approximately 1000 km, the pneumatic vehicle tire can undergo further growth in particular in the shoulder region due to cyclic deformation of the tire.

This growth in the shoulder region can also result in fatigue cracks in the circumferential grooves during the further operation of the tire.

It is therefore an object to provide a pneumatic vehicle tire which has improved fatigue resistance of the circumferential groove.

This is achieved in that a point R of the carcass ply line defined by a projection of a center of the circumferential groove perpendicularly onto the carcass ply line has a first spacing d of at least 0.7 mm to a straight line that connects two points A and B of the carcass ply line, wherein the center of the circumferential groove is determined in a lateral surface applied to the tread surface radially from the outside, wherein the first spacing d is measured perpendicular to the straight line, and wherein the point R is arranged radially outside the straight line, and wherein the point R is arranged centrally between the points A and B as measured along the carcass ply line and has an equal second spacing D to each of the two points A and B, wherein the second spacing D is 1.0 to 2.0 times a width of the circumferential groove measured along the lateral surface.

It has been shown that the mentioned local specification of the arrangement of the carcass ply line radially inside of the circumferential groove is exceptionally well-suited to counteracting the growth caused by an increase in the filling pressure and by cyclic deformations during operation of the tire, in particular of the utility vehicle tire, specifically in the region of the circumferential groove.

As a result of the filling of the tire to the filling pressure intended for operation and as a result of cyclic loading of the tire during operation, the carcass ply undergoes significant tensile loading, resulting in a straightening of the carcass ply and its carcass ply line, and thus a reduction in the curvature in the region of the point R of the carcass ply line, said curvature being influenced by the first spacing d of at least 0.7 mm in the case of the non-filled new tire. This reduction in the curvature and straightening of the carcass ply counteracts the growth of the tire in the region of the circumferential groove, such that the total growth of the tire in this region is advantageously reduced. By contrast, a first spacing d of less than 0.7 mm only results in slight influencing of the tire growth.

It is essential here that the specific arrangement of the carcass ply line is matched to the position of the circumferential groove and to the geometry thereof. The position of the circumferential groove is incorporated into the arrangement of the carcass ply line via the reference point R. The geometry of the circumferential groove, in particular the width of the circumferential groove, is incorporated into the arrangement of the carcass ply line via the second spacing D of the two points A and B from the point R. Here, the point R is arranged centrally between the points A and B as measured along the carcass ply line and has an equal second spacing D to each of the two points A and B. According to the invention, the second spacing D is 1.0 to 2.0 times the width of the circumferential groove measured along the lateral surface. The width of the circumferential groove may be 10.0 mm to 20.0 mm. This makes it possible for the growth of the tire, especially in the region of the circumferential groove, to be matched to the arrangement and geometry of the circumferential groove and optimized. An opening of the circumferential groove and tangential stresses at the groove base of the circumferential groove are thus reduced. This reduces the formation of fatigue cracks in the circumferential groove.

The severity of the reduction in growth in the region of the circumferential groove can be influenced by the selection of the first spacing d. It has been shown that, from a value of d=0.7 mm, the growth is reduced such that the fatigue resistance of the circumferential groove is improved considerably.

A pneumatic vehicle tire, in particular a utility vehicle tire, is thus provided which has improved fatigue resistance of the circumferential groove.

An advantageous embodiment is provided in that the first spacing d is 0.7 mm to 5.0 mm.

It has been shown that such a first spacing d enables particularly low growth in the shoulder region. This enables a particularly low opening of the circumferential groove and further improves the fatigue resistance of the circumferential groove. A first spacing d of more than 5.0 mm may, depending on the tire size and tire contour, result in a change in the tire width and in the shoulder rib contour that is disadvantageous for the tire contact area and tire performance.

An advantageous embodiment is provided in that the second spacing D is 10 mm to 40 mm.

It has been shown that such a second spacing D makes it possible for the suppression of the growth in the shoulder region to be optimized particularly readily to the usual width of the shoulder-side groove.

An advantageous embodiment is provided in that the carcass ply line in the entire region between the points A and B is arranged so as to have a curvature facing a tire interior space.

This allows the growth of the tire in the region of the circumferential groove as a result of a straightening of the carcass ply under tensile stress to be particularly efficiently counteracted.

An advantageous embodiment is provided in that the carcass ply line axially inside of the points A and B is arranged so as to have a curvature facing a tire exterior space.

This additionally contributes to the growth of the tire in the region of the circumferential groove as a result of a straightening of the carcass ply under tensile stress being particularly efficiently counteracted.

An advantageous embodiment is provided in that both axial halves of the tire are formed in this way.

It is thus possible to improve the fatigue resistance of the shoulder-side circumferential grooves in both halves of the tire.

An advantageous embodiment is provided in that the strength members of the carcass ply in a sidewall of the tire form an angle of at most 10°, preferably of at most 5°, particularly preferably of at most 3°, with the radial direction rR.

The described disadvantageous growth appears in particular in tires having a carcass ply whose strength members in the sidewall form an angle of at most 10°, preferably of at most 5°, particularly preferably of at most 3°, with the radial direction. The advantages of the invention come into particular effect in a tire with such an angle of the carcass strength members, in particular in a tire with a radial carcass.

An advantageous embodiment is provided in that the circumferential groove is the axially outermost circumferential groove having a third spacing of at least 20 mm from a tread surface edge measured along the axial direction aR.

The circumferential groove may thus be what is known as a shoulder groove. The change in the carcass as a result of the filling generally increases axially toward the outside. However, the tire growth has only a lower-level negative effect on circumferential grooves that are arranged at a third spacing of less than 20 mm away from the tread surface edge. Therefore, this type of tire design for the axially outermost circumferential groove having a third spacing of at least 20 mm from the tread surface edge is particularly advantageous. A circumferential groove in particular has a width of 10.0 mm to 20.0 mm.

An advantageous embodiment is provided in that the tire has a nominal aspect ratio of 45% to 80%.

The nominal aspect ratio is ascertained according to E.T.R.T.O. standard. The nominal aspect ratio is usually indicated on the surface of the tire sidewall.

An advantageous embodiment is provided in that the tire is a utility vehicle tire, preferably a truck tire.

Growth-related appearance of fatigue in the region of the circumferential groove can be reduced particularly in the case of utility vehicle tires, in particular truck tires, by the design embodiment according to the invention of the pneumatic vehicle tire. The invention is thus particularly advantageous for utility vehicle tires, in particular truck tires, having a nominal aspect ratio of 45% to 80%.

All embodiments of the pneumatic vehicle tire according to the invention that are represented in this description are merely examples of the design embodiment of the invention. Accordingly, further embodiments of the invention, which are the subject matter of the invention, unless explicitly explained otherwise in the description, are also provided by individual features or a plurality of features of one embodiment alone or by the combination of the features of different embodiments.

Further features, advantages and details of the invention will now be explained in more detail with reference to the schematic drawings, which represent exemplary embodiments. In the drawings:

FIG. 1 shows a cross section of a pneumatic vehicle tire according to the invention.

### BRIEF SUMMARY OF DRAWINGS

FIG. 1 shows a cross section of a pneumatic vehicle tire 1, in particular of a utility vehicle tire.

### DETAILED DESCRIPTION

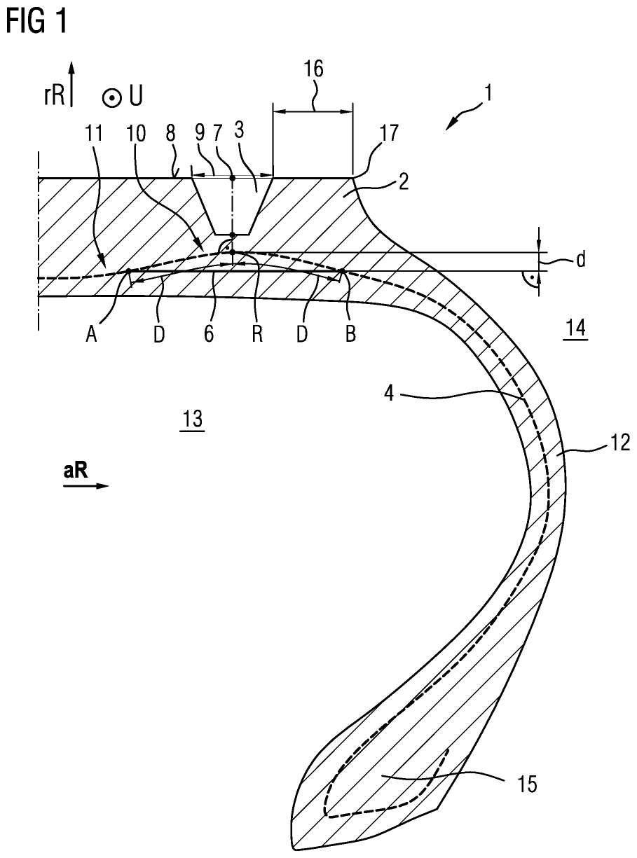

FIG. 1 shows a cross section of a pneumatic vehicle tire 1, in particular of a utility vehicle tire, according to the invention. The cross section is taken perpendicular to the circumferential direction U. The cross section is embodied as the cross section that the tire 1 would have in the new state if the tire were mounted on a standard wheel rim conforming to E.T.R.T.O. without filling pressure.

The essential components from which the pneumatic vehicle tire 1 is composed are a largely air-impermeable inner layer, an in particular radial carcass which has a carcass ply and conventionally extends from the zenith region of the pneumatic vehicle tire via sidewalls 12 into bead regions and is anchored there by being looped around tension-resistant bead cores 15, a profiled tread 2 located radially outside the carcass and a belt arranged between the tread 2 and the carcass.

The tread 2 has a tread surface and a shoulder-side circumferential groove 3 running in encircling fashion around the circumference of the tire. Said groove may be what is known as a shoulder groove. The circumferential groove 3 may be the axially outermost circumferential groove 3 having a third spacing 16 of at least 20 mm from a tread surface edge 17 measured along the axial direction aR.

The carcass ply has strength members which are arranged largely parallel to one another and in the sidewalls 12 of the tire form an angle of at most 10°, preferably of at most 5°, particularly preferably of at most 3°, with the radial direction rR. The carcass may be in the form of a radial carcass. The carcass ply 4 has, in the cross section of the tire, a carcass ply line 4 running through the central points of the strength members of the carcass ply.

The tire according to the invention is distinguished in that, in the illustrated cross section, a point R of the carcass ply line 4 defined by a perpendicular projection of a center 7 of the circumferential groove 3 onto the carcass ply line 4 has a first spacing d of at least 0.7 mm to a straight line 6 that connects two points A and B of the carcass ply line.

In this case, the center 7 of the circumferential groove is determined in a lateral surface 8 applied to the tread surface radially from the outside. The first spacing d is measured perpendicular to the straight line 6. The point R is arranged radially outside the straight line 6. The point R is arranged centrally between the points A and B as measured along the carcass ply line 4 and has an equal second spacing D to each of the two points A and B. The second spacing D is 1.0 to 2.0 times a width 9 of the circumferential groove 3 measured along the lateral surface 8.

The first spacing d can be 0.7 mm to 5.0 mm. The second spacing D can be 10 mm to 40 mm. The width 9 of the circumferential groove 3 can be 10.0 mm to 20.0 mm.

As illustrated, the carcass ply line 4 in the entire region between the points A and B can have a curvature 10 facing a tire interior space 13. The carcass ply line 4 axially inside of the points A and B can be arranged so as to have a curvature 11 facing a tire exterior space 14.

Both axial halves of the tire 1 can have a corresponding design of the carcass ply line 4.

The tire can have a nominal aspect ratio of 45% to 80%. The nominal aspect ratio is ascertained according to E.T.R.T.O. standard. The nominal aspect ratio is usually indicated on the surface of the tire sidewall.

1-10. (canceled)

11. A pneumatic vehicle tire comprising:
a tread with a tread surface and a shoulder-side circumferential groove;
a carcass with a carcass ply having strength members;
a carcass ply line in a cross section of the tire and running through central points of the strength members;
the cross section is in a circumferential direction U mounted on a standard wheel rim conforming to E.T.R.T.O. without filling pressure;
a point R of the carcass ply line is defined by a projection of a center of the circumferential groove perpendicularly onto the carcass ply line and has a first spacing d of at least 0.7 mm to a straight line that connects two points A and B of the carcass ply line;
the center is determined in a lateral surface applied to the tread surface radially from the outside;
the first spacing d is measured perpendicular to the straight line;
the point R is arranged radially outside the straight line;
the point R is arranged centrally between the points A and B as measured along the carcass ply line and has an equal second spacing D to each of the two points A and B, wherein the second spacing D is 1.0 to 2.0 times a width of the circumferential groove measured along the lateral surface.

12. The pneumatic vehicle tire of claim 11, wherein the first spacing d is 0.7 mm to 5.0 mm.

13. The pneumatic vehicle tire of claim 12, wherein the second spacing D is 10 mm to 40 mm.

14. The pneumatic vehicle tire of claim 11, wherein the carcass ply line (4) in the entire region between the points A and B is arranged so as to have a curvature (10) facing a tire interior space (13).

15. The pneumatic vehicle tire of claim 11, wherein the carcass ply line (4) axially inside of the points A and B is arranged so as to have a curvature (11) facing a tire exterior space (14).

16. The pneumatic vehicle tire of claim 11, wherein both axial halves of the tire are formed in this way.

17. The pneumatic vehicle tire of claim 11, wherein the strength members of the carcass ply in a sidewall of the tire form an angle of at most 10°, preferably of at most 5°, particularly preferably of at most 3°, with the radial direction rR.

18. The pneumatic vehicle tire of claim 11, wherein the circumferential groove is the axially outermost circumferential groove having a third spacing of at least 20 mm from a tread surface edge measured along the axial direction aR.

19. The pneumatic vehicle tire of claim 11, wherein the tire has a nominal aspect ratio of 45% to 80%.

20. The pneumatic vehicle tire of claim 11, wherein the tire is a truck tire.
